(19) United States
(12) Patent Application Publication
(10) Pub. No.: US 2019/0197501 A1
(43) Pub. Date: Jun. 27, 2019

(54) Systems and Methods for Use in Facilitating Network Transactions

(71) Applicant: MASTERCARD INTERNATIONAL INCORPORATED, Purchase, NY (US)

(72) Inventors: David J. Senci, Troy, IL (US); Samuel Gerald Bish, St. Louis, MO (US); Kyle Williams, O'Fallon, MO (US)

(21) Appl. No.: 15/851,048

(22) Filed: Dec. 21, 2017

(51) Int. Cl. G06Q 20/10; G06Q 20/32; G06Q 20/38; G06Q 20/40

(52) U.S. Cl. CPC G06Q 20/102; G06Q 20/401; G06Q 20/388; G06Q 20/3223

(57) ABSTRACT

Systems and methods are provided for facilitating network transactions. One exemplary method includes receiving a request for at least one recurring network transaction involving a first party, based on a prior network transaction with the first party and including multiple attributes. The method also includes soliciting at least one variable attribute of the at least one recurring network transaction from a user associated with the prior transaction, receiving the at least one variable attribute from the user, and compiling and storing a recurring transaction order based on the multiple attributes of the prior transaction and the at least one variable attribute. The exemplary method then further includes initiating the at least one recurring network transaction, based on a timing defined by the recurring transaction order, whereby the prior transaction and its multiple attributes provide a template for the at least one recurring network transaction.

### FIELD

The present disclosure generally relates to systems and methods for use in facilitating network transactions and, in particular, to systems and methods for use in permitting users to identify network transactions, and then to establish recurring network transactions based on the identified network transactions.

### BACKGROUND

This section provides background information related to the present disclosure which is not necessarily prior art.

Merchants are known to offer various different products (e.g., goods and services, etc.) for sale to consumers, and consumers are known to purchase such products. The purchases are sometimes funded through payment accounts, whereby the transactions are payment account transactions. From time to time, products may be purchased by consumers with the consumers paying for the products later (i.e., the consumers are billed for the products and then later pay the bills). Healthcare products are examples of such products for which consumers are sometimes billed, rather than funding the transactions in advance, or at the time of delivery. In connection therewith, healthcare providers are known to provide flexibility in receiving payments from consumers for healthcare products, such that the consumers may, for example, be permitted to pay in installments over periods of time.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in facilitating recurring network transactions based on prior transactions with a merchant;

FIG. 2 is a block diagram of a computing device that may be used in the exemplary system of FIG. 1;

FIG. 3 is an exemplary method that may be implemented in connection with the system of FIG. 1 for use in facilitating recurring network transactions to a merchant, based on a prior transaction involving the merchant;

FIG. 4 illustrates an exemplary interface that may be provided through a network-based application associated with an issuer in connection with the system of FIG. 1 and/or the method of FIG. 3; and.

FIG. 5 illustrates an exemplary recurring transaction interface, overlaid on the exemplary interface of FIG. 4, that may be used to create a recurring transaction in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers, from time to time, owe funds to merchants for previously delivered, or to be delivered, products. In connection therewith, it may not be possible, or desirable, for the consumers, for example, to fully pay the funds owed to the merchants for the products at the time of purchase, whereby the consumers may instead pay the funds over time in lesser installments. In doing so, the consumers contact the merchants (e.g., healthcare providers, etc.) at one or more intervals (e.g., monthly, etc.) and initiate payment account transactions to make the installment payments.

Uniquely, the systems and methods herein permit a consumer to access prior transactions with a merchant, and to set up one or more recurring transactions based on one or more of the prior transactions with the merchant. In particular, the consumer may be able to view prior the transactions, via a network-based application associated with an issuer of a payment account of the consumer. In connection therewith, the issuer also provides the consumer with an option to make one or more of the transactions a recurring transaction. Upon selection by the consumer to make a prior transaction a recurring transaction, a recurring transaction engine is invoked and solicits variable attributes from the consumer for the recurring transaction. The recurring transaction engine then compiles and stores a recurring transaction order, which includes the recurring transaction as defined by the variable attributes, and also the attributes of the prior transaction (e.g., merchant ID, merchant account number, primary account number (PAN), etc.), whereby the prior transaction is used as a template for the recurring transaction. Thereafter, the recurring transaction is initiated as defined by the recurring transaction order. In this manner, repeat initiation of a transaction by the consumer, to fulfill an installment obligation, may be avoided. As such, installment payments for products to merchants may be made more efficient.

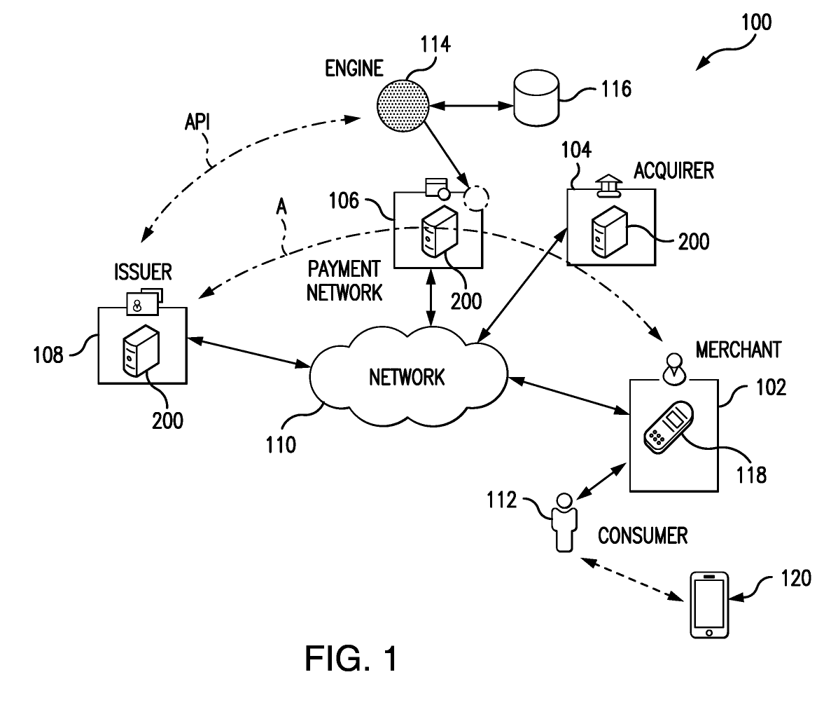

FIG. 1 illustrates an exemplary system 100 in which one or more aspects of the present disclosure may be implemented. Although the system 100 is presented in one arrangement, other embodiments may include systems arranged otherwise depending, for example, on processing of payment account transactions, delivery of transaction data, manners in which payment account transactions are initiated, privacy concerns, etc.

In the illustrated embodiment, the system 100 generally includes a merchant 102, an acquirer 104, a payment network 106, and an issuer 108, each coupled to (and in communication with) a network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which is accessible as desired to the merchant 102, the payment network 106, the issuer 108, and one or more various consumers in the system 100 (e.g., consumer 112, etc.), etc.

The merchant 102 in the system 100 is generally associated with products (e.g., goods and/or services, etc.) for purchase by one or more consumers (including consumer 112). The merchant 102 may offer the products for sale through a physical storefront and/or a virtual storefront, etc., for example, to the consumer 112. In general, the merchant 102 provides products of the type where one or more consumers are unable, or unwilling, to pay a full price for the products at one time. In addition, although not required in all applications of the system 100, the merchant 102 typically will seek to collect the funds from the consumers for the purchase of the products after delivery of the products to the consumers. In one example, the merchant 102 is a healthcare provider, or affiliate, which has rendered medical care for the consumer 112.

In this exemplary embodiment, the consumer 112 is associated with a payment account, which is issued to the consumer 112 by the issuer 108. The consumer 112 may rely on the payment account to fund transactions with the merchant 102 (and/or with other merchants in the system 100 but not shown). The consumer 112 is also associated with a communication device 120. The communication device 120 may include a smartphone, a tablet, a personal computer, a laptop, a desktop, a workstation, a PDA, etc., which is coupled to and/or is in communication with the issuer 108, for example, via the network 110.

With that said, to initiate a transaction with the merchant 102, the consumer 112 will call or otherwise contact the merchant 102, or physically be present at the merchant 102, to present credentials for the consumer's payment account. For example, the consumer 112 may read a primary account number (PAN), etc., to an operator at the merchant 102, or present a payment device (e.g., a credit card, a debit card, a prepaid card, the communication device 120 when enabled with a payment application, etc.) to the merchant 102. Thereafter, the merchant 102 provides a transaction amount and the credential and/or payment device to a point of sale (POS) terminal 118. In response, via the POS terminal, the merchant 102 generates an authorization request for the transaction to be funded by the consumer's payment account and communicates the authorization request to the acquirer 104 (along path A in FIG. 1).

In turn, the acquirer 104 communicates the authorization request with the issuer 108 along path A, generally through the payment network 106, such as, for example, through the MasterCard®, VISA®, Discover®, or American Express® payment network, etc. Upon receipt, the issuer 108 determines if the consumer's payment account is in good standing and if there is sufficient funds and/or credit to cover the transaction. If approved, an authorization reply (indicating the approval of the transaction) is transmitted by the issuer 108 back to the merchant 102, again along path A, thereby permitting the merchant 102 to complete the transaction. The transaction is later cleared and/or settled by and between the merchant 102, the acquirer 104, and the issuer 108. Conversely, if the transaction is declined, an authorization reply (indicating a decline of the transaction) is provided by the issuer 108 back to the merchant 102, thereby permitting the merchant 102 to halt or terminate the transaction or request an alternative form of payment.

Transaction data is generated, collected, and/or stored as part of the above exemplary interactions among the merchant 102, the acquirer 104, the payment network 106, the issuer 108, and/or the consumer 112. The transaction data includes a plurality of transaction records, one for each transaction, or attempted transaction. The transaction records, in this exemplary embodiment, are stored at least by the payment network 106 (e.g., in a data structure associated with the payment network 106, etc.), but could be stored in other parts of the system 100 and transmitted as needed or requested. As used herein, transaction data may include, for example (and without limitation), payment tokens and related token information, PANs and/or other payment account credentials, amounts of the transactions, merchant IDs for merchants involved in the transactions, merchant category codes (MCCs), balances, payment history dates/times of the transactions/payments, incentives used (e.g., rebates discounts, etc.), etc. It should be appreciated that more or less information related to transactions, as part of either authorization or clearing and/or settling, may be included in transaction records and stored within the system 100, at the merchant 102, the acquirer 104, the payment network 106 and/or the issuer 108.

In various exemplary embodiments, consumers (e.g., consumer 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

While one merchant 102, one acquirer 104, one payment network 106, one issuer 108, one consumer 112, and one communication device 120 are included in the system 100 illustrated in FIG. 1, it should be appreciated that any number of these entities, devices, and/or persons (and their associated components) may be included in the system 100, or may be included as a part of systems in other embodiments, consistent with the present disclosure.

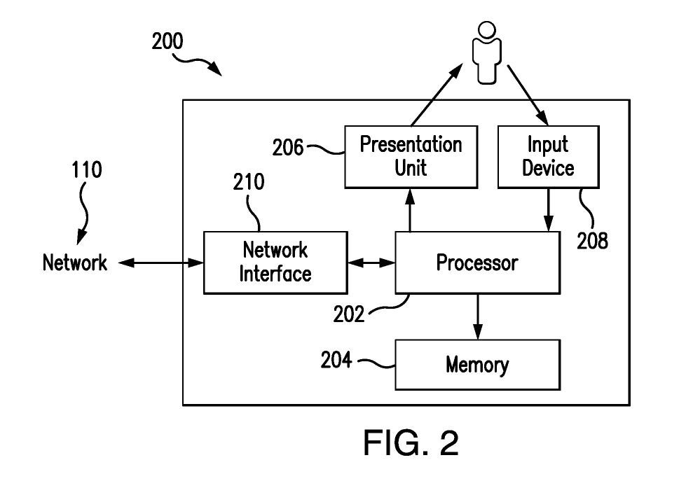

FIG. 2 illustrates an exemplary computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the acquirer 104, the payment network 106, and the issuer 108 are illustrated as including, or being implemented in, computing device 200, coupled to the network 110. In addition, the merchant's POS device 118 and the consumer's communication device 120 may each be considered a computing device consistent with computing device 200. What's more, the merchant 102 may further include and/or be implemented in at least one computing device consistent with the computing device 200. That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, data relating to recurring transactions, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., recurring transaction options, transaction histories, etc.), either visually or audibly, to a user of the computing device 200, for example, the consumer 112, users associated with other parts of the system 100, etc. Various interfaces (e.g., as defined by network-based applications, webpages, short message service (SMS) messages, emails, etc.) may also be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user of the computing device 200 (i.e., user inputs) such as, for example, selections to establish recurring transactions, attributes of the recurring transactions, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some exemplary embodiments, the computing device 200 may include the processor 202 and one or more network interfaces (including the network interface 210) incorporated into or with the processor 202.

Referring again to FIG. 1, the payment network 106 of the system 100 includes a recurring transaction engine 114 and a transaction ledger data structure 116. The recurring transaction engine 114 is coupled to (and is in communication with) the transaction ledger data structure 116, and is specifically configured, by executable instructions, to perform one or more of the operations herein. In connection therewith, the recurring transaction engine 114 and the transaction ledger data structure 116 may each be considered a computing device consistent with computing device 200. While the recurring transaction engine 114 and the transaction ledger data structure 116 are illustrated as separate parts of the system 100 in FIG. 1, one or both may be incorporated into and/or located at one or more other parts of the system 100 (e.g., at the payment network 106 as indicated by the arrow in FIG. 1, at the issuer 108, etc.). In addition, while the transaction ledger data structure 116 is illustrated as separate from the recurring transaction engine 114 in the system 100, in other embodiments the transaction ledger data structure 116 may be included, or integrated, in the recurring transaction engine 114, for example, in memory 204 therein, etc.

In operation of the system 100 (in connection with configuring a recurring transaction by the consumer 112 at the merchant 102), the issuer 108 is initially configured to provide or otherwise make available a network-based application, such as, for example, a website, etc., to the consumer 112. The consumer 112, then, may access the network-based application, at the communication device 120. In so doing, the consumer 112 may provide one or more login credentials to the network-based application, whereupon the consumer 112 is logged in, for example, to his/her account with the issuer 108, etc. Through such access, the consumer 112 may view outstanding balances of his/her payment account, prior transactions (which may or may not themselves involve recurring transactions), etc., or take action within the payment account (e.g., pay bills, pay off balances, etc.), through one or more interfaces of the network-based application. Uniquely, the issuer 108 is configured to offer an option through the network-based application, via a prior transaction interface, whereby the consumer 112 is able to set up one or more recurring transactions based on one or more of the consumer's prior transactions (again, where the one or more prior transactions may or may not itself/themselves involve a recurring transaction).

In connection with the network-based application provided by the issuer 108, it should be noted that the recurring transaction engine 114 is configured to expose an application programming interface (API) to one or more issuers, including the issuer 108. In this exemplary embodiment, the API is tied to the option in the prior transaction interface at the issuer's network-based application to facilitate the various operations described herein.

As such, upon selection of the option to set up a recurring transaction, the issuer 108 is configured to call the API associated with the recurring transaction engine 114, as shown in FIG. 1, thereby permitting the recurring transaction engine 114 to interact with the consumer 112 at the communication device 120. In response, the recurring transaction engine 114 is configured to solicit one or more variable attributes from the consumer 112, via one or more interfaces at the communication device 120 (again via the API). In turn, the consumer 112 provides the solicited one or more variable attributes. Upon receipt of the variable attributes, the recurring transaction engine 114 is configured to generate a recurring transaction order, based on the multiple attributes of the corresponding prior transaction and based on the received variable attributes, and store the same in the transaction ledger data structure 116. The recurring transaction order thus includes, for each recurring transaction, attributes of the prior transaction and the consumer's variable attributes. Various types of attributes of the prior transaction that may be included in the recurring transaction order include, for example and without limitation, a merchant ID for the merchant involved in the prior transaction, a terminal ID, a merchant account number, an MCC for the merchant, the merchant's acquirer, the consumer's PAN, the monetary amount of the prior transaction, token(s) and/or related token(s) information, reference number(s), and/or any other type of transaction data that may be necessary to initiate a recurring transaction, etc. Again, it should be appreciated that this listing of attributes is exemplary only and that one or more of the attributes may or may not be included in the recurring transaction order. In general, though, the recurring transaction order may typically include (or mimic) the attributes from the authorization request for the prior transaction (with some modifications to indicate that the recurring transaction is a new transaction (e.g., transaction date, transaction time, transaction amount, inclusion of a recurring indicator, transaction reference number, etc.)). And, the types of variable attributes that may be included in the recurring transaction order include, for example and without limitation, the monetary amount of the recurring transaction, the timing of the recurring transaction, the rate of the recurring transaction, the number of recurring transactions, and/or any other types of attribute that may be necessary to initiate the recurring transaction, etc.

In setting up the recurring transaction, it should be appreciated that the recurring transaction order may rely on the variable attributes received from the consumer 112, over the attributes of the prior transaction, when there is a conflict, or vice-versa. For example, the recurring transaction order may include a monetary amount received via the API, rather than the monetary amount included in the prior transaction, to thereby give the consumer 112 flexibility in requesting the recurring transaction. In this regard, when a consumer provides a particular variable attribute of a type(s) (e.g., monetary amount) that is the same as a type(s) of attribute(s) included in the prior transaction (e.g., monetary amount), the recurring transaction engine 114 may be configured to compile the recurring transaction order based, at least in part, on the particular variable attribute(s) provided by the consumer, but not the particular attribute(s) from the prior transaction, thereby allowing the consumer's particular variable attribute(s) to take precedence (e.g., the consumer's specified monetary amount will be used in the recurring transaction order, and not the monetary amount of the prior transaction). It should be appreciated, however, that in this instance, the recurring transaction engine 114 may still be configured to compile the recurring transition order based, in part, on other attribute(s) of the prior transition. It should also be appreciated that the recurring transaction engine 114 may collect, from the prior transaction data, all prior transaction data and generate the recurring transaction order based on all, or a subset of, the collected prior transaction data or, alternatively, may collect only a subset of the prior transaction data and generate the recurring transaction order based on all, or a further subset of, the collected prior transaction data (e.g., only the transaction data necessary to initiate a recurring transaction, etc.).

Subsequently in the system 100, at a timing defined by the recurring transaction order, the recurring transaction engine 114 is configured to compile an authorization request for the recurring transaction, consistent with the prior transaction (e.g., such that the authorization request for the recurring transaction mimics the authorization request for the prior transaction except for any attribute(s) changed by the consumer 112 and any other modifications required to identify the authorization request as being actually associated with the recurring transaction (as described above), etc.). As such, the authorization request is generally directed to the same merchant 102 and funded by the same payment account of the consumer 112.

The recurring transaction engine 114 is configured to then submit the authorization request to the merchant 102, and more specifically, to a payment gateway and/or acquirer 104 associated with the merchant 102, the payment network 106, and/or the issuer 108, thereby initiating the recurring transaction. For example, in one implementation the recurring transaction engine 114 may generate the authorization request, generally, on behalf of the merchant 102 (and acquirer 104) and transmit (via a pull operation) the authorization request to the issuer 108. In another implementation, the recurring transaction engine 114 may generate the authorization request (again generally on behalf of the merchant 102 and acquirer 104) and then transmits the authorization request to the acquirer 104 (as a push operation), whereby the acquirer 104 then transmit the authorization request to the issuer 108 in a conventional manner. In any case, the authorization request is ultimately received at the issuer 108, again either directly from the recurring transaction engine 114, or via another entity in FIG. 1. Thereafter, the issuer 108 decides to approve or decline the recurring transaction, whereby processing of the recurring transaction is consistent with the description above, with the transaction being approved, cleared and settled.

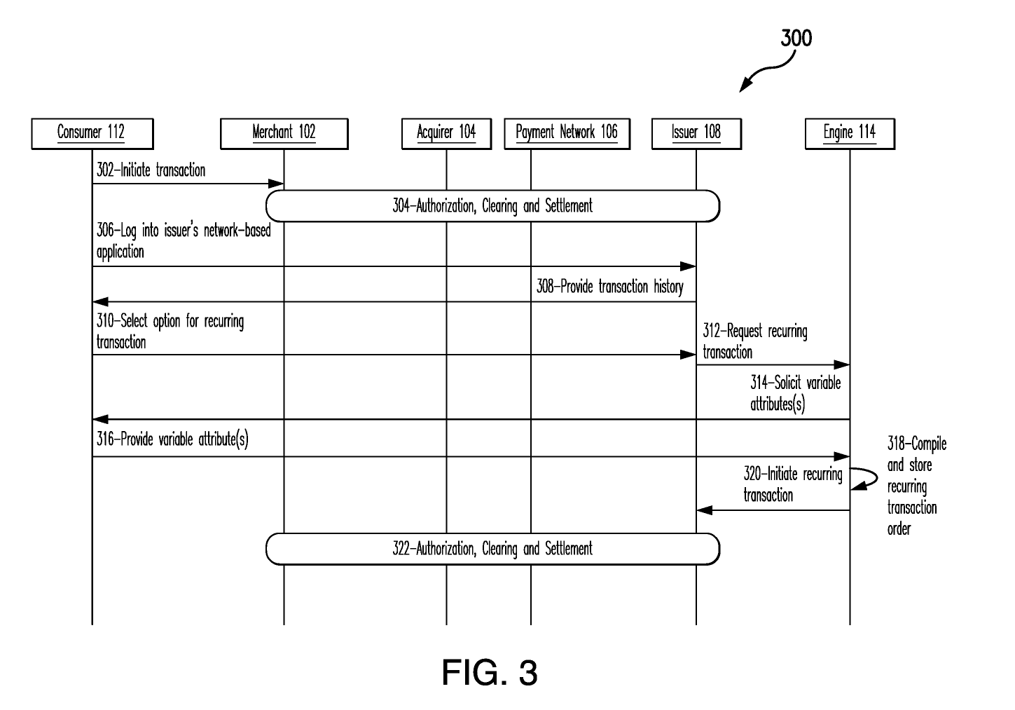

FIG. 3 illustrates an exemplary method 300 for use in facilitating recurring transaction to a merchant based on prior transactions involving the merchant. The exemplary method 300 is described as implemented in the system 100 with reference made to the issuer 108, the consumer 112, the recurring transaction engine 114 and the transaction ledger data structure 116, and further with reference to computing device 200. However, it should be understood that the method 300 is not limited to this configuration of the system 100, as the method 300 may be implemented, at least in part, in other parts of the system 100, or in multiple other computing devices or systems. As such, the methods herein should not be understood to be limited to the exemplary system 100 or the exemplary computing device 200, and likewise, the systems and the computing devices herein should not be understood to be limited to the exemplary method 300.

At the outset in the method 300, the consumer 112 has received a product, such as one or more medical services, etc., from the merchant 102, for example, whereby the consumer 112 owes the merchant a particular amount of money (e.g., $1000 in the following discussion, etc.). In addition, the consumer 112 has agreed, through a telephone call with the merchant 102 or otherwise, to pay $50 per month, with an initial payment immediately of $100 (where the initial payment, in this example, is not itself a recurring transaction). As such, in FIG. 3, at 302, the consumer 112 initiates, at the outset, a transaction with the merchant 102 for the agreed-upon $100 initial payment by providing payment account credentials to the merchant 102 for the consumer's payment account. In turn, as generally referenced at 304, the merchant 102, the acquirer 104, the payment network 106, and issuer 108 cooperate to provide authorization, clearing and settlement of the initial transaction (as generally described above in the system 100). Specifically, the merchant 102, through the POS device (or terminal) 118, compiles an authorization request for the transaction, which generally includes (without limitation) one or more of the name of the consumer 112, the PAN for the consumer's payment account, an expiration date of a payment device associated with the consumer's payment account, a merchant ID for the merchant 102, an amount for the transaction (i.e., $100), a time/date of the transaction, etc., and transmits the authorization request along path A in FIG. 1 to the issuer 108, to seek authorization of the initial transaction (and to facilitate subsequent clearance and settlement of the transaction among the parties shown).

It should be appreciated that the initial transaction described above (and the $100 amount associated therewith) is merely exemplary, and that other prior transactions, in the same amount or some different amount, may be included in other method embodiments. It should also be appreciated that this initial transaction is then referred to as a “prior transaction” in the following discussion. However, it should be appreciated the recurring transaction engine 114 may identify other transactions for use in generating the recurring transaction in other embodiments (e.g., such as a first $50 payment transaction, etc.). Further, while the prior transaction in this example (i.e., the initial payment of $100) is not itself a recurring transaction, in other embodiments a prior transaction may actually be a recurring transaction itself.

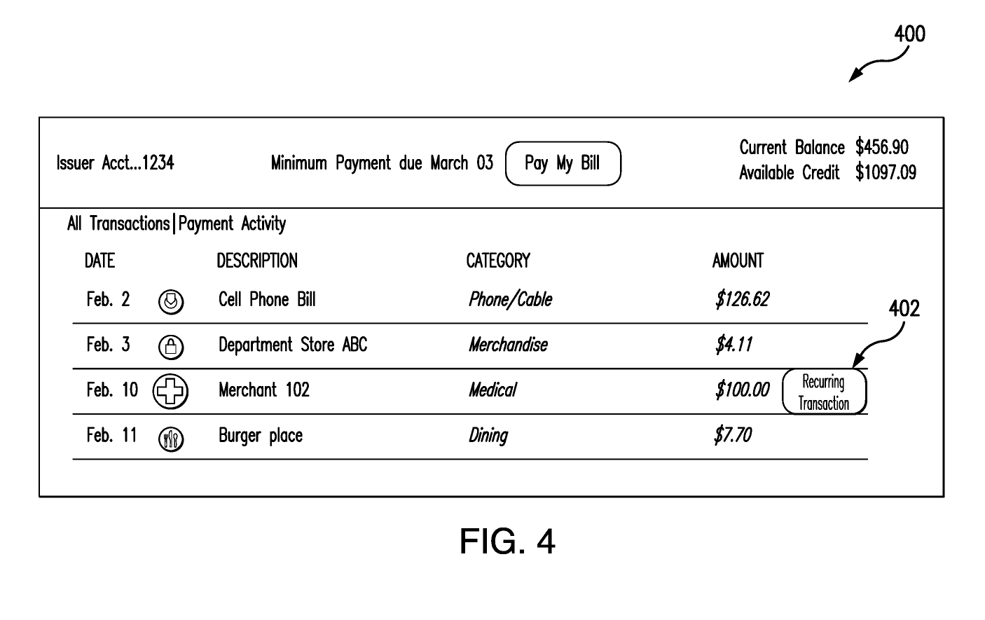

Subsequently in the method 300, at 306, the consumer 112 logs into the network-based application provided by the issuer 108, which, in this embodiment, is a website (i.e., the issuer website, etc.). In other embodiments, though, the network-based application may be provided by parties or parts of the system 100 other than the issuer 108. Upon such access, and in response to one or more inputs from the consumer 112, the issuer 108, via the website, provides a transaction history for the payment account to the consumer 112, at 308 (for viewing, review, etc.). In this embodiment, the transaction history is provided in a webpage interface. In connection therewith, FIG. 4 illustrates an exemplary interface 400, which may be displayed to the consumer 112 at his/her communication device 120 to provide the transaction history to the consumer 112 for his/her payment account. As shown, the interface 400 relates to the consumer's payment account identified by the last four digitals of the PAN (i.e., “1234”), and informs the consumer 112 that the payment account has a balance of $456.90. The interface 400 also displays four prior transactions to the consumer 112, from February 2nd to February 11th. The third of the listed prior transaction is the prior transaction with the merchant 102, which was initiated at 302. And, the interface 400 includes an option button 402 to request a “Recurring Transaction” for this prior transaction with the merchant 102.

Upon viewing the webpage interface of prior transactions (e.g., interface 400, etc.) at the issuer's webpage, the consumer 112, consistent with the agreement with the merchant 102, selects to make the prior transaction with the merchant 102 a recurring transaction (e.g., the consumer 112 selects the option button 402 at the interface 400, etc.) and requests, at 310, to establish one or more recurring transactions based thereon. In response, the issuer 108 transmits a request, at 312, for the one or more recurring transactions, via an API call, to the recurring transaction engine 114. In general, the request from the issuer 108 may include the transaction data for the prior transaction at the merchant 102 (e.g., mimicking the transaction data included in the authorization request for the prior transaction (as described above), etc.), but with certain transaction data updated to reflect that the request is actually for the recurring transaction (e.g., transaction date and time, transaction amount, transaction reference number, number of recurring transactions, occurrence of the transactions (e.g., monthly, weekly, etc.), etc.). That said, it should be appreciated that in various embodiments the request from the issuer 108 may include all transaction data related to the prior transaction or, alternatively, only a subset of the transaction data related to the prior transaction (e.g., only the transaction data necessary to initiate a recurring transaction, etc.). It should also be appreciated that the API need not be hosted at the recurring transaction engine 114 and may be hosted elsewhere, for example, at the issuer 108. In this instance, a call to the API hosted at the issuer 108 may be routed to the recurring transaction engine 114.

With continued reference to FIG. 3, the recurring transaction engine 114, in response to the request, determines what data is known and/or what data is needed in order to establish a recurring transaction for the consumer 112. Based on the determination, the recurring transaction engine 114 solicits, at 314, one or more variable attributes for the one or more recurring transactions from the consumer 112, at the communication device 120 (via an API, etc.). In this exemplary embodiment, the recurring transaction engine 114 solicits the variable attributes through an interface, such as, for example, a recurring transaction interface. In turn, the consumer 112 provides the requested variable attributes to the recurring transaction engine 114 (via input device 208 of the communication device 120, etc.).

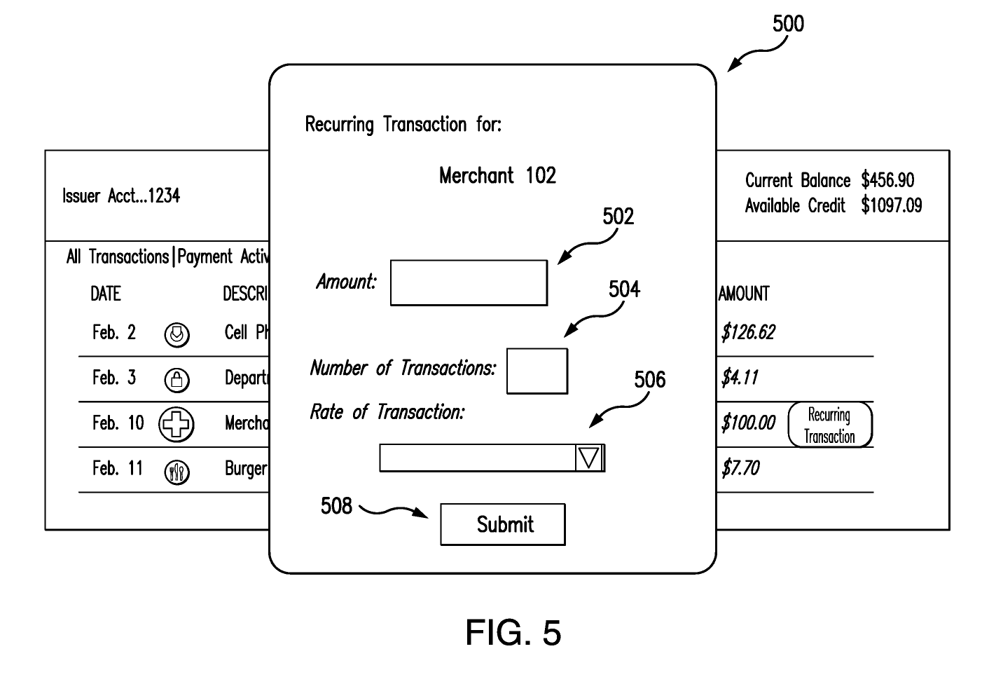

In connection therewith, FIG. 5 illustrates an exemplary recurring transaction interface 500 that may be displayed to the consumer 112 at the communication device 120 for soliciting and receiving variable attributes from the consumer 112. As shown, the interface 500 solicits an amount 502 for the recurring transaction(s), a number 504 of recurring transactions to be scheduled (e.g., a number of times for the at least one recurring network transaction to be completed, etc.), and a rate 506 of the transactions (all, broadly, variable attributes). In this example, the variable attributes are provided by entering the transaction amount and the number of transactions and, through a pull down menu, selecting the rate for the transactions (e.g., which may include weekly, bi-weekly, monthly, etc.). When the consumer 112 provides the appropriate variable attributes, which for the above example are $50 for the amount, eighteen for the number of total transactions, and monthly for the rate, the consumer 112 selects “Submit” button 508, whereby the consumer 112 provides the variable attributes to the recurring transaction engine (e.g., at 316 in the method 300, etc.).

Next in the method 300, the recurring transaction engine 114 receives the variable attributers from the consumer 112, and compiles and stores, at 318, a recurring transaction order for the requested recurring transaction in the transaction ledger data structure 116. The recurring transaction order thus includes the attributes of the transaction received from the issuer 108 (at 312), whereby the prior transaction acts as a template for the recurring transaction, and also the variable attributes provided from the consumer 112, via the API (at 316).

At some time later, as indicated by the recurring transaction order, the recurring transaction engine 114 initiates, at 320, a payment account transaction for the next one of the recurring transactions (consistent with the attributes of the prior transaction and the variable attributes in the order). In so doing, the recurring transaction engine 114 compiles and transmits an authorization request for approval of the given recurring transaction as generally described above in the system 100. For example, in one implementation the recurring transaction engine 114 may generate the authorization request, generally, on behalf of the merchant 102 (and acquirer 104) and transmit the authorization request directly to the issuer 108 (at 320). In this implementation, the merchant 102 and/or acquirer 104 would then receive a notification from the issuer 108 indicating whether the transaction was approved or declined (as an authorization reply). Alternatively, in another implementation, the recurring transaction engine 114 may generate the authorization request (again generally on behalf of the merchant 102 and acquirer 104) and transmit the authorization request to the acquirer 104 (or potentially a payment gateway) associated with the merchant 102, whereby the acquirer 104 (or payment gateway) then transmits the authorization request to the issuer 108 in a conventional manner (all as part of the operation 320). In any case, the authorization request is ultimately received at the issuer 108, at 320. Thereafter, the issuer 108 decides to approve or decline the recurring transaction, and the merchant 102, the acquirer 104, the payment network 106, and the issuer 108 cooperate to authorize, clear, and settle the recurring transaction, at 322.

Regardless of how the recurring transaction engine 114 initiates the transaction, the recurring transaction engine 114 will continue to initiate transactions, as defined by the recurring transaction order, stored in the transaction ledger data structure 116, until all such transactions are initiated or the order is cancelled by the consumer 112, etc.

In view of the above, the systems and methods herein permit a consumer to fulfill recurring payment obligations over a transaction network without having to repeatedly initiate transactions to fulfill those obligations. The systems and methods herein permit the consumer to do so by way of a new recurring transaction engine that is specially adapted, arranged, and located to function in relation to, and in conjunction with, existing transaction networks, thereby improving conventional transaction network technology and processes and modifying the routine operation thereof. Uniquely, in the manner described above, the transaction engine is adapted, arranged, and located to leverage existing, prior transaction data to generate and initiate a new recurring transaction order, while at the same time allowing a consumer customize, as necessary, the recurring transaction order.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein. As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a computing device, a request for at least one recurring network transaction involving a first party, the at least one recurring network transaction based on a prior network transaction with the first party, the prior network transaction including multiple attributes; (b) soliciting, by the computing device, at least one variable attribute of the at least one recurring network transaction from a user associated with the prior transaction; (c) receiving, by the computing device, the at least one variable attribute from the user; (d) compiling and storing, by the computing device, a recurring transaction order, the recurring transaction order based on the multiple attributes of the prior transaction and the at least one variable attribute, the recurring transaction order defining a timing of the at least one recurring network transaction; and (e) initiating the at least one recurring network transaction based on the timing defined by the recurring transaction order, whereby the prior transaction provides a template including the multiple attributes of the prior transaction for the at least one recurring network transaction.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating at least one recurring network transaction, based on a prior transaction, the method comprising:
receiving, at a computing device, a request for at least one recurring network transaction involving a first party, the at least one recurring network transaction based on a prior network transaction with the first party, the prior network transaction including multiple attributes;
soliciting, by the computing device, at least one variable attribute of the at least one recurring network transaction from a user associated with the prior transaction;
receiving, by the computing device, the at least one variable attribute from the user;
compiling and storing, by the computing device, a recurring transaction order, the recurring transaction order based on the multiple attributes of the prior transaction and the at least one variable attribute, the recurring transaction order defining a timing of the at least one recurring network transaction; and
initiating the at least one recurring network transaction based on the timing defined by the recurring transaction order, whereby the prior transaction provides a template including the multiple attributes of the prior transaction for the at least one recurring network transaction.

2. The computer-implemented method of claim 1, wherein the first party includes a merchant and the user includes a consumer associated with a payment account; and
wherein the multiple attributes of the prior transaction include a primary account number (PAN) for the payment account associated with the consumer.

3. The computer-implemented method of claim 2, wherein the multiple attributes further include a merchant ID for the merchant.

4. The computer-implemented method of claim 3, wherein the at least one variable attribute includes an amount of the at least one recurring network transaction and a number of times for the at least one recurring network transaction to be completed.

5. The computer-implemented method of claim 2, wherein soliciting the at least one variable attribute includes soliciting the at least one variable attribute from the consumer via an application programming interface (API), provided through a network-based application associated with an issuer of the payment account.

6. The computer-implemented method of claim 5, wherein receiving the request includes receiving the request, via the API, from the issuer, in response to a selection by the consumer at the network-based application.

7. The computer-implemented method of claim 2, wherein initiating the at least one recurring network transaction includes transmitting, by the computing device, an authorization request to an issuer associated with the payment account of the consumer, the authorization request including the multiple attributes of the prior transaction and being consistent with the at least one variable attribute.

8. The computer-implemented method of claim 1, wherein initiating the at least one recurring network transaction includes initiating multiple recurring network transactions, the timing of each of the multiple recurring network transactions being defined by the recurring transaction order.

9. The computer-implemented method of claim 1, wherein the at least one recurring network transaction includes multiple recurring network transactions; and
wherein the at least one variable attribute of the at least one recurring network transaction consists of at least one of: an amount of each of the multiple recurring network transactions, a number of the multiple recurring network transactions, and a rate of the multiple recurring network transactions.

10. A system for use in facilitating recurring payment transactions, based on prior transactions, the system comprising:
a transaction ledger data structure; and
a computing device coupled to the transaction ledger data structure, the computing device configured to:
solicit, from a consumer, at least one variable attribute for multiple recurring transactions, the multiple recurring transactions based on a prior transaction, the prior transaction associated with multiple attributes including a merchant ID for a merchant involved in the prior transaction and a payment account credential for a payment account associated with the consumer;
receive, from the consumer, the at least one variable attribute for the multiple recurring transactions; and
compile and store, in the transaction ledger data structure, a recurring transaction order for the recurring transactions, the recurring transaction order indicating, for each of the multiple recurring transactions, a timing, an amount, and the multiple attributes of the prior transaction, thereby permitting the multiple recurring transactions to be initiated.

11. The system of claim 10, wherein the computing device is further configured to initiate each of the multiple recurring transactions consistent with the timing and the multiple attributes for the recurring transaction.

12. The system of claim 11, wherein the computing device is further configured to generate an authorization request for each of the multiple requested recurring transactions and transmit the authorization request to one of an issuer associated with the payment account of the consumer and an acquirer associated with the merchant, thereby initiating each of the multiple recurring transactions.

13. The system of claim 10, wherein the multiple attributes further include a merchant account number and at least one of an account number for the merchant, a merchant category code (MCC) for the merchant, an indication of an acquirer for the merchant, and a monetary amount of the prior transaction.

14. The system of claim 13, wherein the computing device is further configured to:
expose an application programming interface (API) to an issuer of the payment account associated with the consumer;
receive a request for the multiple recurring transactions, via the API, in connection with a network-based application associated with the issuer; and
receive the at least one variable attribute of the multiple requested recurring transactions from the consumer via the API.

15. A non-transitory computer readable storage media comprising executable instructions for facilitating recurring payment transactions that, when executed by at least one processor, cause the at least one processor to:
receive a request for at least one recurring network transaction involving a first party, the at least one recurring network transaction based on a prior network transaction with the first party, the prior network transaction including multiple attributes;
receive, from a second party associated with the prior network transaction, at least one variable attribute of the at least one recurring network transaction;
compile a recurring transaction order based on at least one of the multiple attributes and the at least one variable attribute, the recurring transaction order defining a timing of the at least one recurring network transaction; and
initiate the at least one recurring network transaction, based on the timing defined by the recurring transaction order.

16. The non-transitory computer readable storage media of claim 15, wherein the first party includes a merchant and the second party includes a consumer associated with a payment account; and
wherein the at least one of the multiple attributes of the prior transaction includes a primary account number (PAN) for the payment account associated with the consumer and a merchant ID for the merchant.

17. The non-transitory computer readable storage media of claim 15, wherein the at least one variable attribute includes an amount of the at least one recurring network transaction and a number of times for the at least one recurring network transaction to be completed.

18. The non-transitory computer readable storage media of claim 15, wherein the executable instructions, when executed by the at least one processor, cause the at least one processor, in connection with receiving the request for at least one recurring network transaction, to receive the request for the at least one recurring network transaction via an application programming interface (API) exposed to an issuer of a payment account in connection with a network-based application associated with the issuer; and
wherein the executable instructions, when executed by the at least one processor, cause the at least one processor, in connection with receiving the at least one variable attribute, to receive the at least one variable attribute of the at least one recurring network transaction from the second party via the API.

19. The non-transitory computer readable storage media of claim 15, wherein the received at least one variable attribute is associated with a type and wherein each of the multiple attributes is associated with a type; and
wherein the executable instructions, when executed by the at least one processor, further cause the at least one processor, in connection with compiling the recurring transaction order, to, when the type of the at least one variable attribute is the same as the type of one of the multiple attributes, compile the recurring transaction order based, at least in part, on the received variable attribute, and not based on the one of the multiple attributes having the same type as the at least one variable attribute.

20. The non-transitory computer readable storage media of claim 15, wherein initiating the at least one recurring network transaction comprises generating and transmitting an authorization request for the at least one recurring network transaction.
